(19) United States
(12) Patent Application Publication
(10) Pub. No.: US 2003/0023594 A1
(43) Pub. Date: Jan. 30, 2003

(54) System and method for organizing, preserving, sharing and updating voluminous personal memoirs and for dynamic accounting of assets

(76) Inventor: Ram K. Ramamurthi, Allen, TX (US)

Correspondence Address: HOWISON, THOMA & ARNOTT, L.L.P, P.O. BOX 741715, DALLAS, TX, 75374-1715, US

(21) Appl. No.: 10/050,247

(22) Filed: Jan. 15, 2002

Related U.S. Application Data
(60) Provisional application No. 60/308,060, filed on Jul. 25, 2001.

(51) Int. Cl. G06F 7/00

(52) U.S. Cl. 707/7

(57) ABSTRACT

A method is disclosed for storing personal records in a data processing system, such as personal photographs, video and audio recordings The personal records are first sorted into a preselected order defined according to a selected input scheme, and then input into a data processing system. Index codes are automatically assigned to the personal records, with the index codes corresponding to the sequence in which the personal records are input into the data processing system. The personal records are formatted for remote display and the personal records are automatically sorted according to the index codes. The personal records are grouped into display sets according to the assigned index codes, and display codes incorporated into the index codes. A display set of the personal records is then displayed as a web page in response to a remote display request.

### BACKGROUND OF THE INVENTION

Consumers may obtain electronic copies of personal photographs, either by taking the photographs with digital cameras and other electronic photographic equipment, or by having photographs taken on conventional photographic film stored in electronic form, such as by having the conventional photographic film scanned into electronic form and then storing the electronic images on a compact disk (“C.D.”). Electronic copies of photographs are often stored on a personal computer. Some businesses provide software which attempts to organize the images on a user's personal computer (“P.C.”). In general, it is relatively easy to organize a few photographs from a single roll of film. While a small number of photographs may be automatically stored on a C.D. by scanning a roll of conventional film, it is a tedious task for a user to load stored images on a P.C., and then to format and organize the stored images on an image by image basis. When organizing a large number of personal photographs accumulated over many years, the task becomes extremely tedious. Additionally, P.C.'s and C.D.'s provide access which is generally limited to one user at a time, providing limited access for remote sharing.

Other problems arise if a person wishes to share electronically stored photographs with viewers at remote locations. Several Internet service providers provide personal websites which allow a customer to grant remote access to personal records, such as photographs. One such provider is myfamily.com, which provides storage space for customers to store photographs and other documents, such as diaries, calendar information, phone book information, and the like. However, much like persons who organize electronically stored images on PC's, customers of such Internet service providers typically find the task of organizing and publishing large numbers of photographs difficult and tedious. These customers are usually required to first digitize the collection of photographs, and then upload the photographs to a website, from which the photographs are organized online. Reviewing and organizing numerous photographs via an online connection to a website is very time consuming for the customers, and also uses excessive server time. If the customer wishes to store complex information, such as video tapes, the task of storing and organizing the data becomes even more complicated. In general, such personal websites quickly become obsolete due to lack of maintenance.

### SUMMARY OF THE INVENTION

A method is provided for organizing and electronically storing personalized records, such as photographs, video clips, inventories of personal items, and the like. A client computer is connected to a server computer through a global computer network. The client computer is also connected to devices which digitize or electronically store the personal records. An initial presort is performed to sort the various records into categories, and preferably in chronological order within each category. The customer may personalize each of the categories and then initiate a sort of the records according to the personalized categories. The sorted electronic records are then loaded into the server for electronic storage, and an index code is assigned to each of the records. The index code provides information for each of the records relating to the particular customer who owns the records, the respective categories into which the records are assigned, and a particular sort order for the records within the categories. The sort order within the categories is preferably in chronological order, which may be selectively modified by a customer. The records are automatically sorted according to assigned codes.

For photographs, a cropping algorithm is applied to detect the edges of the images on the photographs, and then to crop the images. After cropping, the images are sized to fit a standard size window, and then stored in the standard size for fitting within the standard size windows. Video clips are analyzed such that dead spaces in the video and sound are removed. Audio clips are similarly analyzed to remove dead space in the sound. The server maps between the codes and the actual images, and creates groupings for presenting the images as part of a personalized web page for a customer. The categories preferably form a navigational tree to aid customers and visitors in navigating the site.

Personal information is collected from a customer to define key calendar dates to provide automatic reminders to trigger the customer to submit new personal records pertaining to the key dates. Additionally, the customer may store inventory records such as photographs of personal belongings as proof for later insurance claims should such personal items be stolen, damaged or destroyed. The customer can grant a person visitor's rights for viewing records in particular categories and selected images within such categories. The customer may also designate private records to which visitors are not granted access.

### BRIEF DESCRIPTION OF THE DRAWINGS

For a more complete understanding of the present invention and the advantages thereof, reference is now made to the following description taken in conjunction with the accompanying Drawings in which:

FIG. 1 is a schematic diagram of equipment for use in one embodiment of the present invention;

FIG. 2 is a flowchart which represents one process for organizing and inputting personal records according to the present invention;

FIGS. 3A and 3B are a flowchart which represents an initial sort of personal records;

FIG. 4 is a flowchart which represents a process for inputting personal records at a remote location from a central server;

FIG. 5 is a flowchart which represents selecting and editing categories for use in sorting and organizing the personal records;

FIG. 6 is a flowchart which represents a process for formatting the personal records;

FIG. 7 is a flowchart which represents a process for assigning display codes for grouping the personal records for display;

FIG. 8 is a flowchart which represents a process for assigning personal identification numbers (“pins”) to a customer and the customer defining access rights to personal records;

FIG. 9 is a flowchart which represents a process for a customer to grant viewing rights to a visitor to allow the visitor to review various personal records of a customer's personal website;

FIG. 10 is a flowchart which represents a process for identifying key calendar dates for a customer, and then alerting the customer to provide new personal records corresponding to the key calendar dates;

FIG. 11 is a flowchart which represents a process of displaying various customer records in response to a customer or visitor request for display of the records;

FIG. 12 is a flowchart which represents a process for electronically storing various records of personal items to provide an electronic inventory of such personal items;

FIG. 13 is a flowchart which represents a process for electronically storing financial records for customer review;

FIG. 14 is a screen view of a display of a customer's web page showing various customer categories and a single grouping of photographs being displayed;

FIG. 15 is a screen view of a personalized web page for a customer;

FIG. 16 is a table showing a first portion of index codes which are used for indexing customer records;

FIGS. 17A and 17B together provide a table showing a second portion of the index codes which corresponds to categories used for indexing customer records;

FIG. 18 is a table showing a third portion of the index codes which corresponds to a chronological sequence of the customer records;

FIG. 19 is a table showing a correlation between parsed index codes and customer categories of input records;

FIG. 20 is a table showing a correlation among the index codes, customer categories, and customer subcategories; and

FIG. 21 is a table depicting a correlation between visitor pins and customer pins.

### DETAILED DESCRIPTION OF THE INVENTION

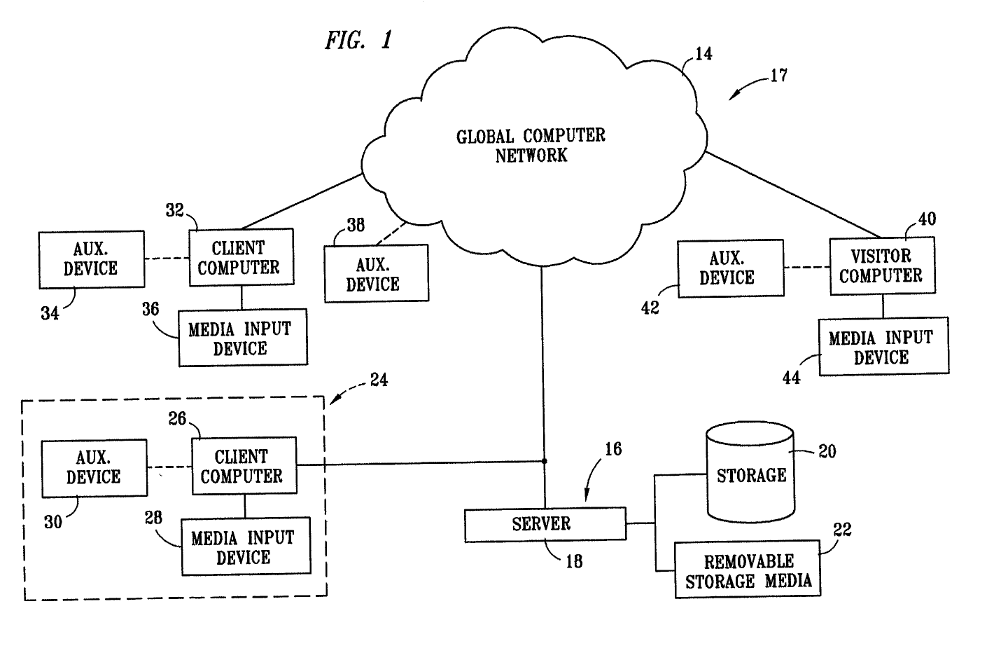

FIG. 1 is a schematic diagram of equipment connected to a global computer network 14 to provide a data processing system 17 for use to store and share personal records according to one embodiment of the present invention. Preferably, the global computer network 14 is connected to storage system 16, which includes a server 18, storage drives 20, and removable storage media device 22. Also shown is a mobile data center 24, such as a portable unit which may be a laptop based unit, or a unit mounted in a truck or van for visiting client locations. The mobile data center 24 maybe staffed by the service provider operating the server 18, and travel to a customer's residence for entering personal records at the customer's residence. The mobile data center 24 has a client computer 26 for connecting directly to the server 16, which may be a direct network link for download upon return to a data processing center where the server 18 is located, or a direct link via telecommunications systems, such as a wireless connection to a land telephone line. The mobile data center 24 further includes a media input device 28 and an auxiliary input device 30 which are connected to the client computer 26. The media input device 28 may be a scanner, or a device for inputting video clips or audio clips. The auxiliary input device 30 may be a device for receiving a magnetic or optically stored personal records.

A client computer 32 is depicted as being connected to a media input device 36 and an auxiliary device 34. The media input device 36 may be a scanner, or a device for inputting video clips or audio clips. The auxiliary device 34 may be a device for receiving a flash disk to input data into the client computer 32 for transferring through the global computer network 14 to the server 18. Also shown is an auxiliary device 38 connected directly to the global computer network for input of digital images, digital video clips or digital audio for transmitting through the global computer network 14 to or from the server 18. The auxiliary device 38 could be provided by PDA's, wireless devices, optical media storage reading devices, or magnetic media devices, such flash disk card readers. Also depicted as connected to the global computer network 14 is a visitor computer 40. The visitor computer 40 may also have an auxiliary device 42 for either reading of electronic images for sending to the client computer 32 for input to the server 18, or for writing copies of various images viewed which are transmitted from the server 18. A media input device 44 may also be connected to the visitor computer 40 for imputing personal records, such as scanning images, or inputting video clips or audio clips. The personal records from visitor computer 40 may be transferred to server 18, provided the customer has granted the visitor using the visitor computer 40 the proper access level rights for uploading personal records to the customer's site stored.

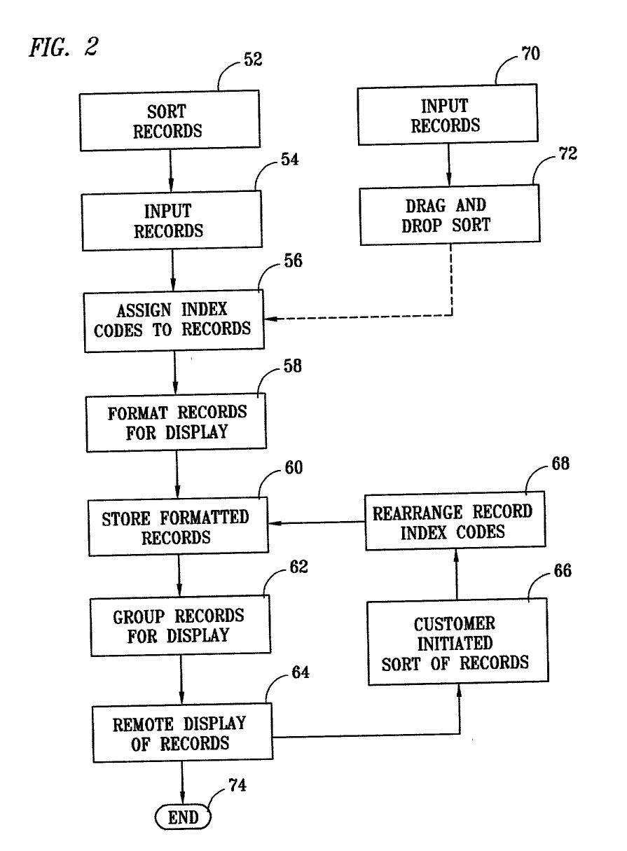

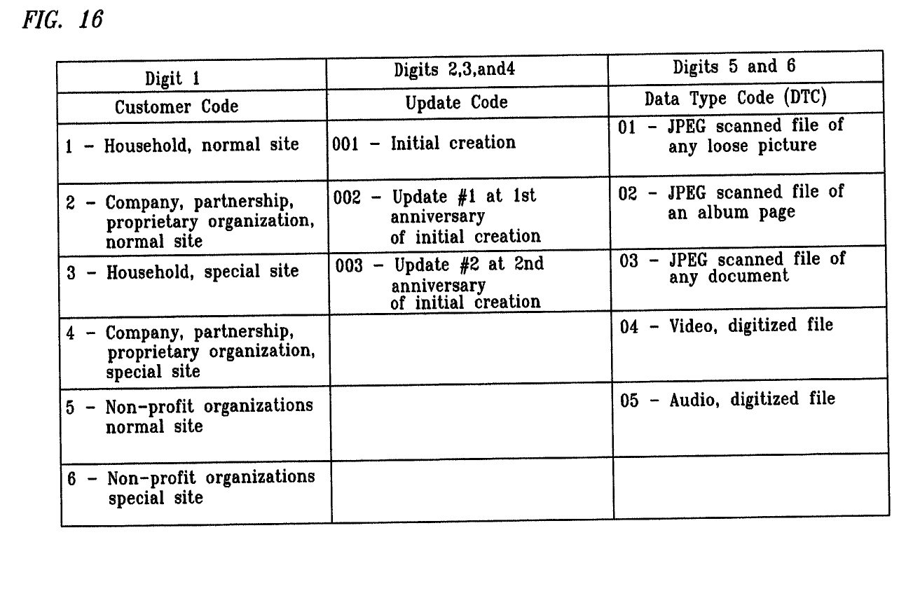

FIG. 2 is a flowchart representing a process for inputting and sorting various personal records into the server 18 for storage in the storage drives 20. First, the personal records are sorted in the step depicted by block 52. The records are sorted into various categories, and preferably in chronological order for each of the various categories. In the step depicted in block 54, the personal records are input into the client computer 26 or 32. The input step 54 is performed by either the auxiliary device 34, the media input device 36, the auxiliary device 38, the media input device 28 or the auxiliary device 30. Additionally, records may be input via the auxiliary device 42 or the media input device 44, and then pass through the visitor computer 40 and the global computer network 14 to the server 18. The steps shown in blocks 52 and 54 are interchangeable, such that the personal records may be first input according to the step shown by the block 54, and then sorted according to the step shown in the block 52. This is shown in the steps of blocks 70 and 72, in which records are first input in the step of block 70, and then a drag and drop sort is performed in the step of block 72. The client computer 26 or 32, or the server 18 will then assign indexing codes to the various personal records in the step depicted in block 56. In the step of block 58, the records are formatted for display by the client computer 26 or 32, or the server 18. The formatted and indexed records are then stored in the server 18 in the step depicted by block 60. In the step of block 62, the records are grouped for display as simultaneous sets of records, in primary groupings according to display codes, which are included as data type codes (“DTC”) in the index codes as described below in reference to FIG. 16. Then, remote display of the records may be initiated by the client computer 32 as shown in the step depicted by block 64. In the step depicted in block 66, the customer may initiate a sort of records. The customer may also sort the records between different categories or redefine the various categories, which redefines the index codes, as depicted in the step of block 68, and then the process returns to the step depicted in block 60 to store the formatted records. The records are then grouped for display in the step depicted in block 62. The records may be remotely displayed, as shown in block 64, and then the process ends in the step of block 74.

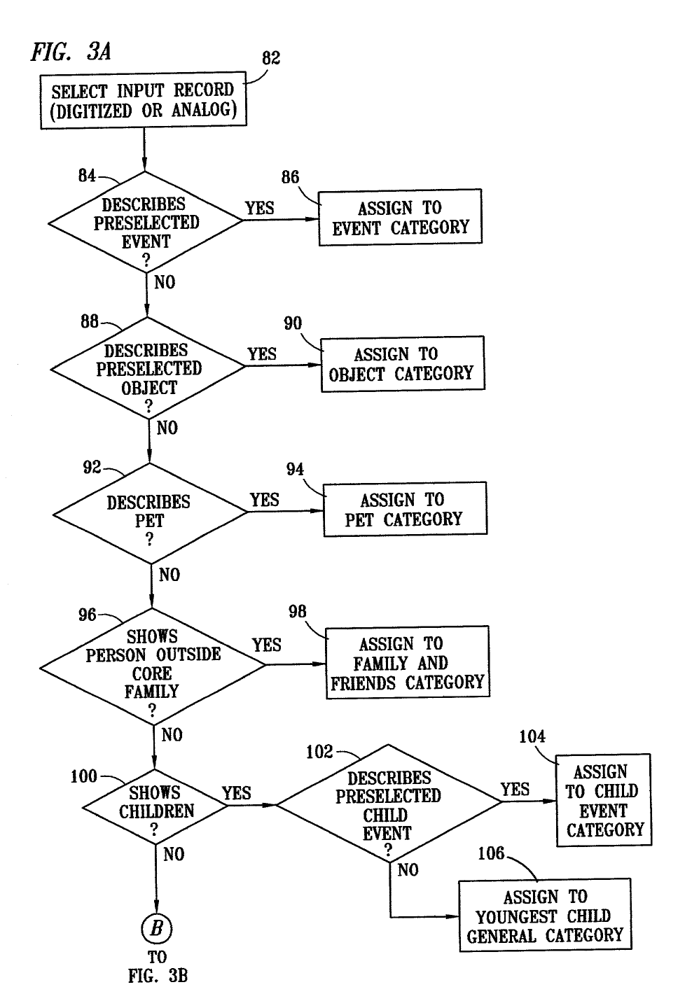

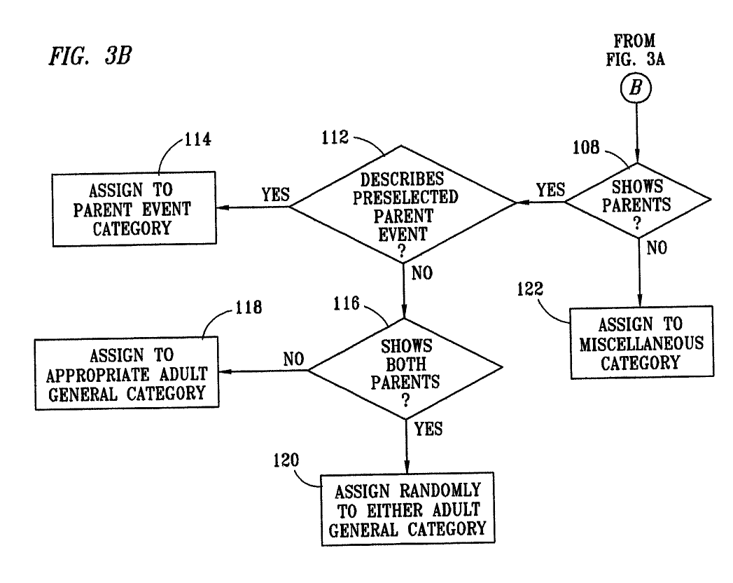

FIGS. 3A and 3B together provide a flowchart for an initial sorting of a personal record, such as that shown in the sort records set of block 52 in FIG. 2. As discussed above, this step may be done either before or after the input records step of block 54 in FIG. 2, such that the records in physical form, such as printed photographs, may be sorted by arranging the order of the photographs prior to being input into a client computer 26 or 32, a visitor computer 40, or the server 18, or this sort may occur after the records are input into electronic form, such as by a drag and drop procedure. In the step depicted in block 82, a personal record is first selected, with the record being in either digital form or as a hard copy, such as a printed photograph. Next, in decision block 84, the record is reviewed to determine whether it describes a preselected event corresponding to one of the defined event categories. If the record does correspond to a preselected event, it is assigned to that preselected event category in the step depicted by block 86. In the step depicted by block 88, the personal record is reviewed to determine whether it corresponds to a previously defined object category. If the record does correspond to a preselected object category, it is assigned to that preselected category in the step depicted by block 90. In the step depicted by block 92, the personal record is reviewed to determine whether it corresponds to a previously defined pet category, such as family pets. If the record corresponds to a preselected pet category, it is assigned to the selected pet category in the step depicted by block 94. In the step depicted by block 96, the personal record is reviewed to determine whether it corresponds to a previously defined category for persons outside of the core family of the customer. If the record does correspond to such a preselected category, it is assigned to the preselected category for persons outside of the customer's core family in the step depicted by block 98. In the step depicted by block 100, the personal record is reviewed to determine whether it corresponds to a previously defined categories for the customer's children. If the record does correspond to a preselected category, it is reviewed to determine whether it describes a category for a child event in the step of block 102. If the record does pertain to a particular, preassigned child event category, the record is assigned to such a category in the step depicted by block 104. If the record pertains to the children, but does not match a particular preassigned child event category, in the step depicted by block 106 the record is assigned to a general category for the youngest of the children shown in the record.

FIG. 3B is a continuation of FIG. 3A, and shows further steps for assigning a record to customer selected categories if the record is not assigned to one of the categories reviewed in FIG. 3A. In decision block 108, the record is reviewed to determine whether it shows the parents in the core family of the customer. If the record does show the parents, it is reviewed in the decision block 112 to determine whether the record is of a selected parent event category, and if so, the record is assigned to the parent event category in the step of block 114. If the record is not assigned to a preassigned parent event category, then in the decision block 116 is it reviewed to determine whether the records shows both parents. If the record does not show both parents, it is assigned to a general category for the adult which is shown in the records. If in the decision block 116 it is determined that the record does show both parents, the record is randomly assigned to a general adult category for either of the parents in the step of block 120. If in the decision block 108 it is determined that the records does not show either of the parents, it is assigned to a miscellaneous category in the step depicted by the block 122.

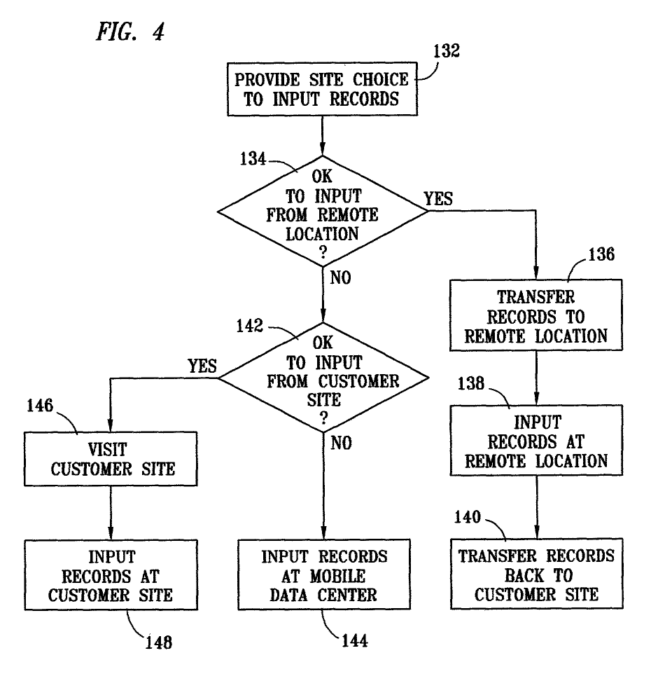

FIG. 4 is a flowchart which represents a process for inputting personal records to the central server 18 from a location which is remote from the central server 18, such as the step of inputting records which is generally depicted in block 54 of FIG. 2. In the step 132, a customer is provided with various site choices for inputting records. In the decision block 134, it is determined whether approval is granted to input records from the remote location. If the appropriate rights have been granted by the customer to allow the service provider to enter the personal records under the customer's account, the process proceeds from the step of block 134 to the step depicted in block 136 of transferring the physical records to a remote location. In the step of block 138 the records are input at the remote location, and then in the step of block 140 the physical and digitized records are preferably transferred back to the customer's site for the customer review on the client computer 32, such that the customer can make a final determination of whether to store the personal records on the server 18. In other embodiments, a customer may grant rights for a visitor to enter the personal records directly into the customer's storage on the server 18 according to index categories selected by the visitor. If approval is not granted to enter the personal records from such a remote location, as determined in the step of block 134, the process proceeds to the step of block 142 in which it is determined whether rights have been granted to enter the personal records from the customer's site with the client computer 32. If such rights are granted, the process will proceed to the step depicted in block 146 of visiting the customer site and then the step 148 of inputting the personal records at the customer site. If in the step of block 142 rights are not granted to input records from the customer site, records may be input from the mobile data center 24 stationed outside the customer site, as depicted in the step of block 144.

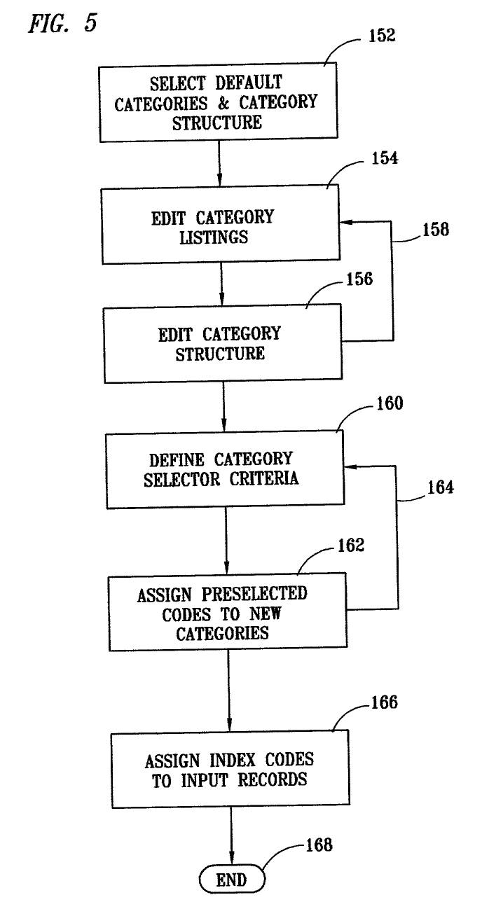

FIG. 5 is a flowchart representing a process for selecting a category structure for assigning personal records to in the step depicted in block 56 of FIG. 2. In the step depicted in block 152, default categories in a category structure are initially selected by a customer. Then, in the step depicted in block 154, the various category listings may be edited by a customer, such as to change the name of, to add or to delete category listings. In block 156 the category structure is also edited, such as to change the sorting order of the categories. The process may then proceed from block 156 to block 154 along a path 158, to edit the category listings and change the category selector criteria. In the step depicted by block 160, various criteria are defined for selecting any new categories under which the personal records will be listed. Then, in the step of block 162, the system will assign preselected codes to the new categories. The process may also return along the path 164, from the block 162 to the block 160, to redefine the various category selector criteria in the step 160. In the step depicted by block 166, the various records are stored in the various selected categories and index codes are assigned to each of the records. The step depicted by block 166 may be performed automatically by the system applying the category selector criteria to assign various index codes to the stored personal records, or the index codes may be manually assigned by a customer in a customer initiated edit.

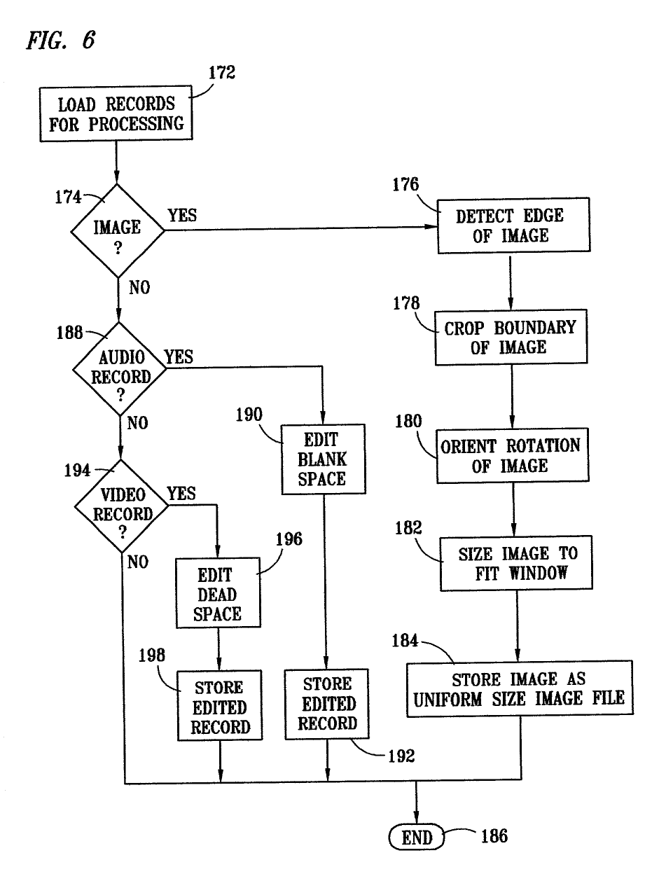

FIG. 6 is a flowchart which represents a process for formatting the records for display which was depicted in the block 58 of FIG. 2, showing more detail. In block 172, records are loaded in a data processing system for processing. In decision block 174, it is determined whether or not the record is a photographic image. If the record is a photographic image, the process will proceed from the decision block 174 to the step of detecting the edge of the image, as shown in block 176. In the step depicted by block 178, the image is cropped at the boundary detected in the step 176. Then, in the step depicted by block 180, the image is oriented to the correct rotation, and sized to fit a preselected size window in the step depicted by block 182. In the block 184, the formatted image is then stored as a uniform size to fit in windows of a preselected size.

If in the decision block 174 it is determined that the record is not a photographic image, the process will proceed to block 188 to determine whether the record is an audio record. If it is determined that the record is an audio record, the process will proceed to the step 190 in which any blank space, or silent space, will be edited from the record to reduce the amount of required storage space. The process will then proceed to the step depicted in block 192, in which the edited record is stored in the disk drive 20 by the server 18.

If in the decision block 188 it is determined that the record is not an audio record, the process will proceed to decision block 194 to determine whether the record is a video record, such as a video clip. If the record is a video record, the process will proceed to the step depicted by block 196 in which the dead space is edited from the video record. The record is then stored in edited form in the step depicted by block 198, preferably in three to four minutes segments. The process will then proceed to the end step of block 186.

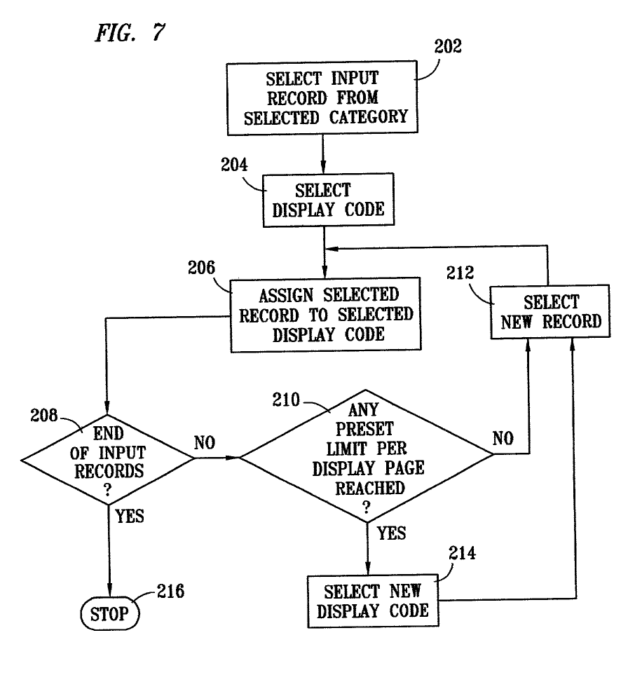

FIG. 7 is a flowchart which represents a process for assigning display codes to the formatted records, which defines groupings of the records for display on a single web page in a selected category, as generally depicted in the step of block 62 of FIG. 2. A record is selected from the category in the step depicted in block 202. In the step of block 204, a display code is assigned which corresponds to the type of image being displayed. The display code corresponds to the data type code (“DTC”) of digits 5 and 6 of the index code depicted in FIG. 16, which indicates both the record type and a display grouping. The records are preferably initially selected in an order corresponding to the chronological sequence code (“CSC”) of FIG. 18, for those records in the selected category being grouped for display. In the step of block 206, the record is assigned the selected display code. In the step of decision block 208, it is determined whether the record is the last of the input records for display in the selected category, and if it is not the last record being assigned to the category in which it is listed, the process will proceed to the step of decision block 210. Decision block 210 depicts the step of determining whether a preset limit of records per page has been reached. Preferably, individual photographs of normal size are assigned to groups of four of the photographs per display page, as shown in FIG. 14. Digitized album pages preferably are grouped with one digitized album page per display page. Iconic symbols for initiating display of video clips are preferably grouped as three iconic symbols per page. If the preset limit per page has not been reached, then the processes proceeds to the step of block 212 and selects a new record for adding to that particular display code. If the preset limit of images per page has been reached, a new display code is selected in the step of block 214, and then the process proceeds to the step of block 212 to select a new record for grouping under the particular display code. The process continues through the steps of blocks 206, 208, 210, 214 and 212, until in the decision block 208 it is determined that the last of the input records has been matched with a display code, and then the process ends with the stop step of block 216. It should also be noted that in other, alternative embodiments, the records may be grouped according to record types and lower level category listings for real time groupings as they are being displayed.

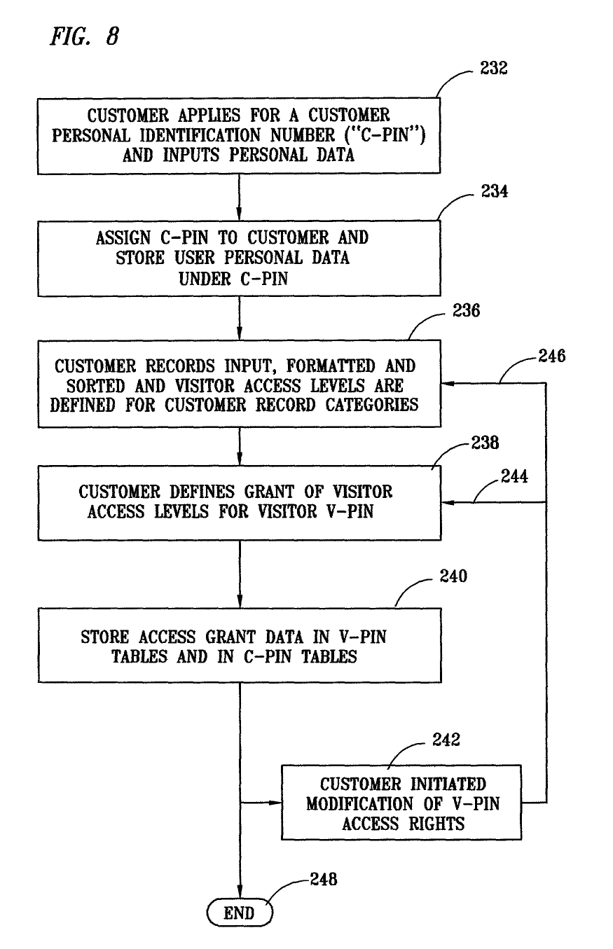

FIG. 8 is a flowchart representing the process of assigning a customer personal identification number (“C-PIN”) to a customer. In the step depicted by block 232, a customer applies for a customer personal identification number (“C-PIN”) and inputs his personal data into the server 18 as part of the application process. The server 18 then assigns a C-PIN to the customer and stores the customer personal data under the C-PIN in the step of block 234. In the step of block 236, the customer records are input, formatted and sorted, and visitor access levels are defined for customer record categories in the step 236. The visitor access levels define the personal record categories to which different visitors are granted access rights, such that friends, parents and other family members may be granted access to different categories of personal records. For example, parents may grant one level of access to grandparents for viewing children, and may grant personal friends a different level of access for viewing different personal records. In the block 238, the step of the customer defining grants of access levels for respective visitor V-PINs is depicted. In the step of block 240, the server 18 stores the access level grant data in a V-PIN and C-PIN table, such as that shown in FIG. 21, for correlating the access grants to various customer records. In the step of block 242, the customer may initiate a modification of V-PIN access rights to assign personal record categories to different access levels, defining which records categories may be viewed by visitors. The process will then proceed along the flow path 244 to the step of the customer defining the grant of access rights for V-PINS of the block 238, or along the flow path 246 to the step of the customer defining the correlation between various access levels and the customer record categories, as depicted in the block 236. The process will then proceed to the end step depicted in block 248.

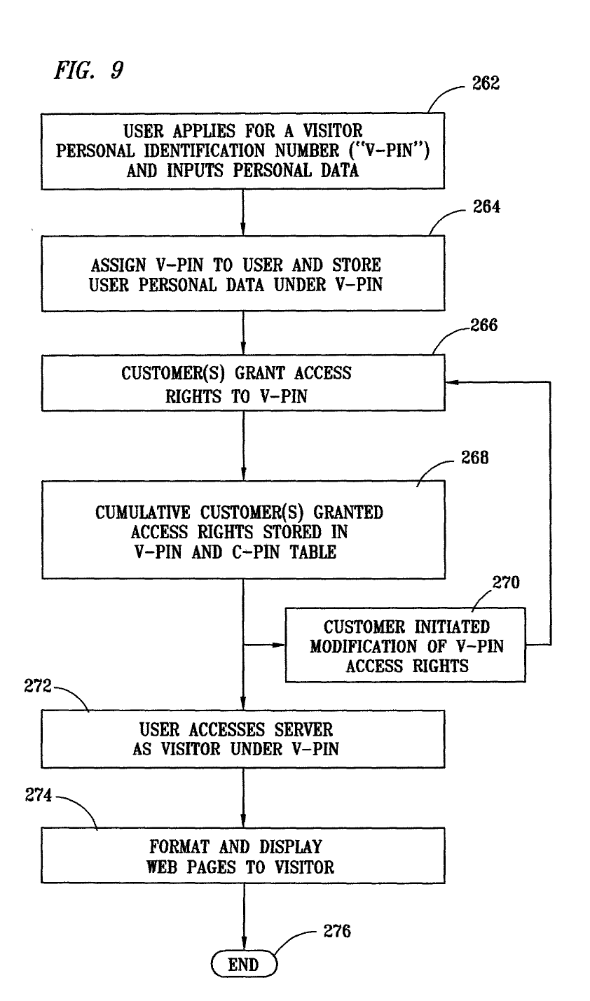

FIG. 9 is a block diagram representing the step of a visitor applying for a visitor personal identification number (V-PIN). In the block 262, the step is depicted of a person applying for a visitor pin and inputting personal data. The server 18 then assigns a V-PIN to the person and stores the visitor's personal data under the V-PIN in the step of the block 264. A customer will then review the V-PIN data and determine whether to grant access rights to the person holding the V-PIN in the step depicted by block 266. In the step of block 268, the cumulative rights granted by the customer to the visitor are stored in a V-PIN and C-PIN table, such as the table shown in FIG. 21. In the step depicted by the block 270, a customer may initiate a modification of the V-PIN access grants, returning to the step depicted in the block 266. The process will then return to the block 268 in which the various rights granted by the customer are stored in the V-PIN and C-PIN table. Then, in the step depicted in the block 272, a person may access the server 18 as a visitor under a V-PIN number. It should be noted that the V-PIN number may be assigned to a customer, such that the customer would not use a C-PIN number to access other person's personal sites, but rather would use an assigned V-PIN number. The V-PIN number have been granted rights to several different customer accounts, with particular levels of viewing rights by each of the respective customers holding the corresponding C-PINs. In the step of block 274, the server 18 formats and displays web pages to the visitor, the web pages showing personal records of the customer. The process then ends in the step depicted by the block 276.

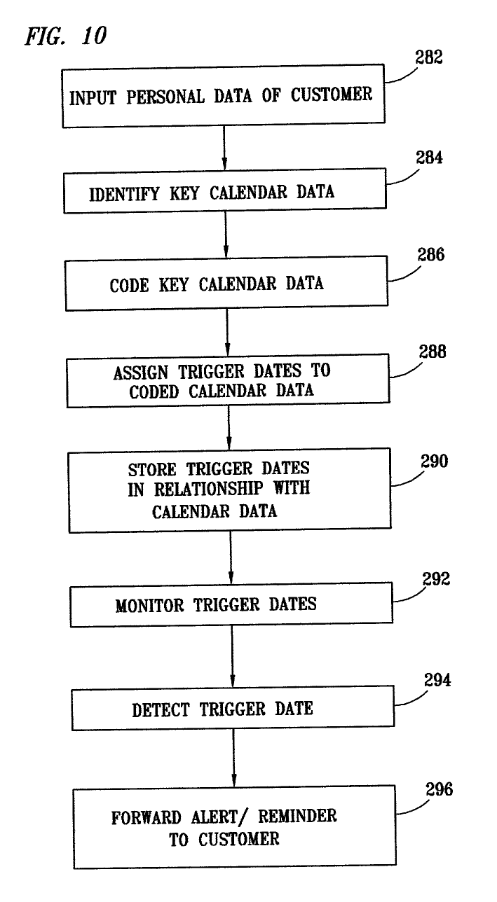

FIG. 10 is a flowchart representing the process of entering various customer personal data, and then the automatic forwarding of alerts and reminders to the customer by the server 18. In the step depicted in block 282, the customer inputs personal data into the server 18, usually when the customer signs up for services, as shown in the block 232 of FIG. 5. Then, the server 18 sorts through the input customer data to identify key calendar data as event dates in the step depicted in the block 284. The server 18 codes the key calendar data as special event dates for storage in the server 18 in the step of block 286. In the step of block 288, trigger dates are assigned to the coded calendar data as dates on which to forward reminders to the customer. In the step of block 290, the trigger dates are stored in relationship with calendar data. In the step depicted in block 292 the server 18 monitors the trigger dates, and, when a trigger date is detected in the step of block 294, the server 18 automatically forwards a reminder as an alert to the customer in the step in block 296. The reminder may be an Email, an automated telephone call, a facsimile, or a letter.

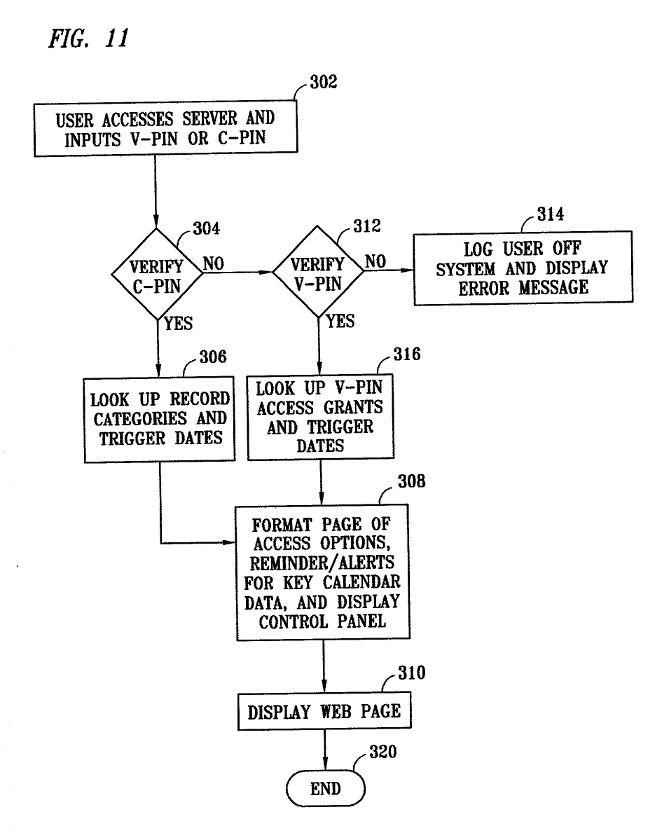

FIG. 11 is a flowchart representing the process of a person accessing the server 18 to view records stored by the system 16. A person first accesses the server 18 in the step of block 302 and inputs either a V-PIN or a C-PIN to log into the server 18. In the step depicted by block 304, the system will then first verify whether a C-PIN has been entered, and if so, it will proceed to look up record categories and trigger dates for that particular customer in the step of block 306. In the step of block 308, a personal web page and the terminal access options are formatted for display to the customer according to records for the verified C-PIN account. A web page will be displayed in the step of block 310. If the personal identification number entered is not a C-PIN, the process will proceed in step of block 312 to verify whether a V-PIN has been entered. If a V-PIN has not been entered, the system will logoff the person and display an error message in the step depicted by block 314. If a V-PIN is verified, the process will proceed to the step depicted by block 316 to look up the access level rights granted to the V-PIN. The system will then proceed to the step of block 308 to format a page of access options, reminders and alerts, key calendar data and display a control panel for selection of various web pages for display. Then, once the visitor selects a particular customer's web pages for display, the process will proceed to the step depicted by the block 310 and will display a web page, with different ones of the personal records in the category being displayed according to the index codes assigned to the records. The process will end in the step 320.

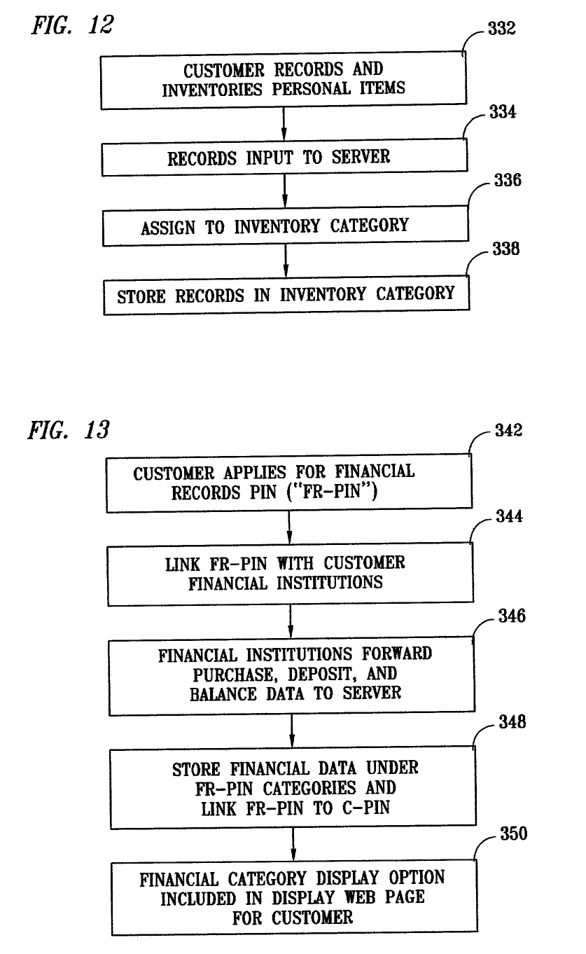

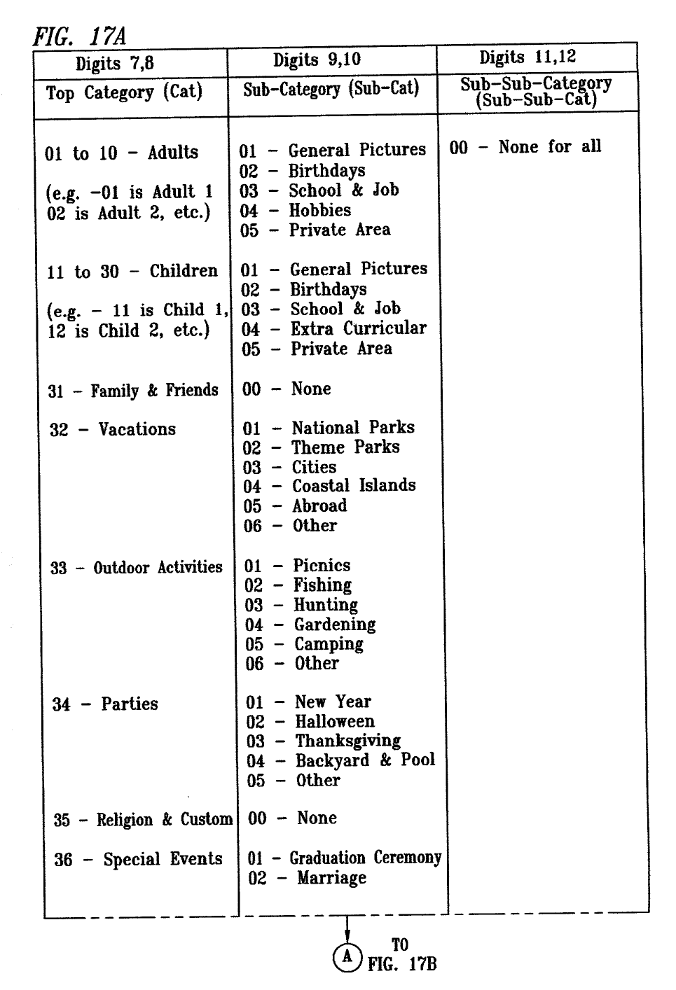

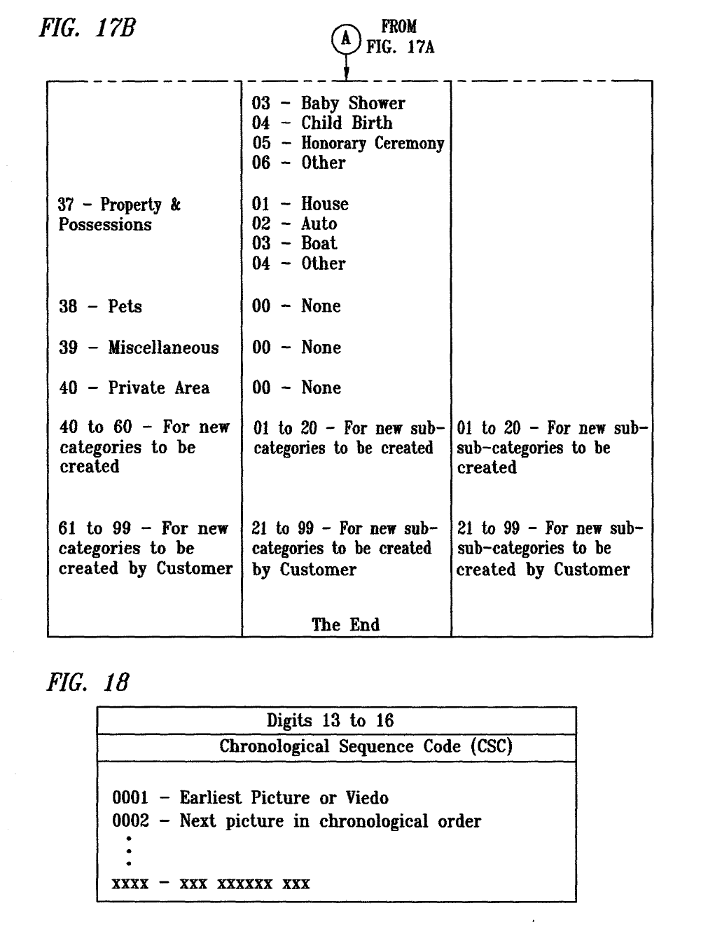

FIG. 12 is a flowchart representing a customer storing records of personal items to create personal items inventories. In the block 332, the step of a customer recording an inventory of personal items is depicted. The records are then input into the server 18 in the step 334, and assigned to an inventory category for a particular C-PIN in the step of block 336. The records are then stored in an inventory category for later retrieval in a step depicted by block 338, with an index code assigned to each record, with the seventh and eighth digits of the index code preferably corresponding to code 37 of FIG. 17B. Preferably, the chronological order of the records is stored as a chronological sequence code (“CSC”), and corresponds to the thirteenth to the sixteenth digits of the index codes, as shown in FIG. 18.

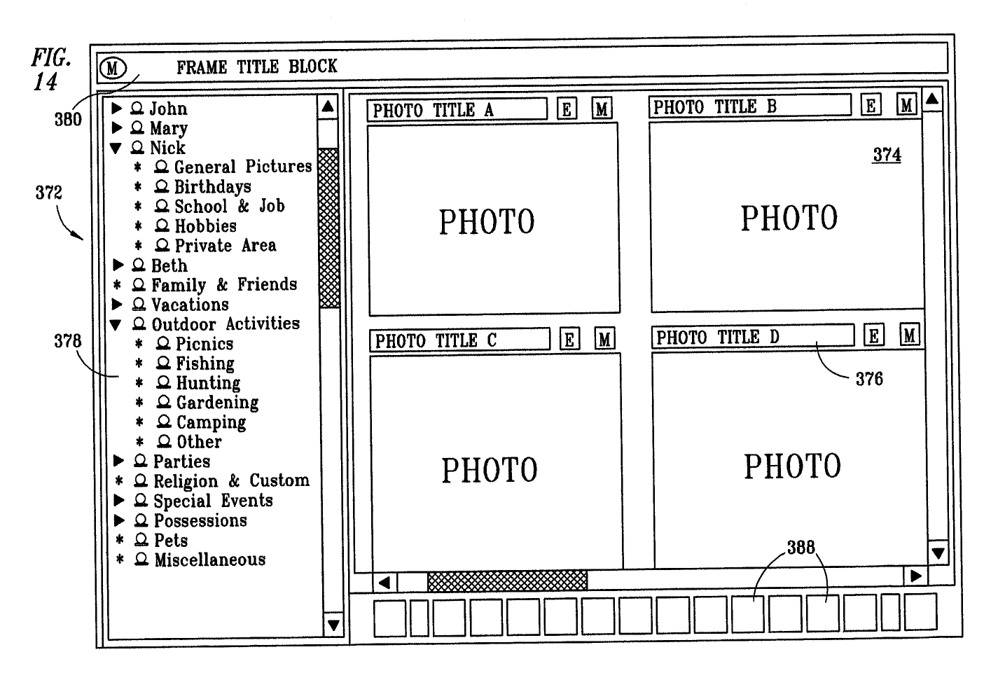

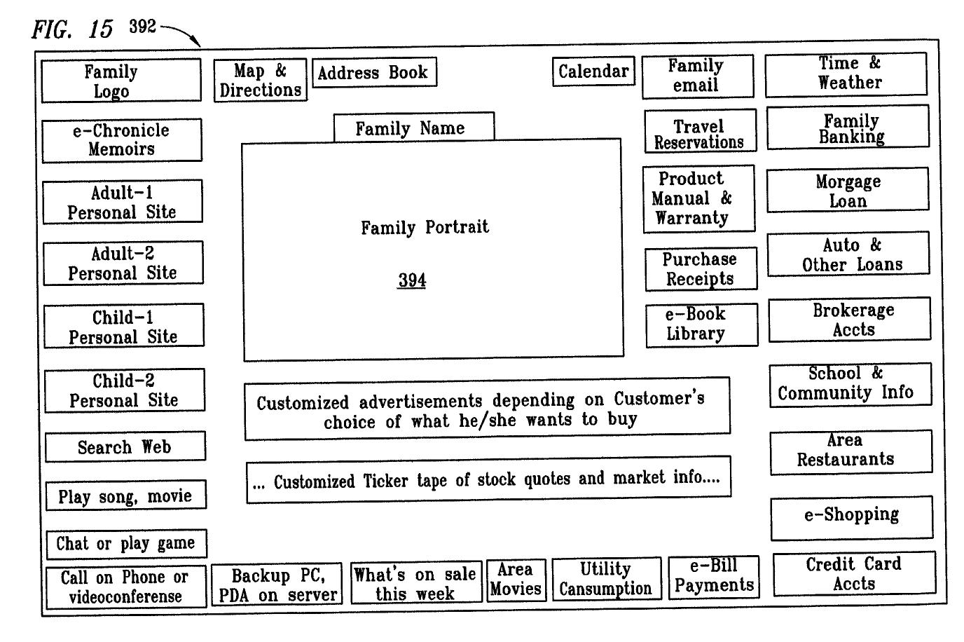

FIG. 13 is a flowchart representing a process for a customer to link personal information from financial institutions for storage of the financial records in the system 16. In the block 342, the customer applies for a financial records pin (“FR-PIN”). In the step of block 344, the server 18 links the FR-PIN with the customer's financial institutions according to data entered by the customer in the step of block 342. In the step of block 346, the link to financial institutions will forward purchase, deposit and balanced data to the server 18 for retrieval by the customer under a linked FR-PIN. The financial data under FR-PIN categories is stored, and links are stored between the FR-PIN and the corresponding C-PIN for a particular customer in the step of block 348. In the step of block 350, a financial category records display option link is then included in the customer's personal web page, as shown in the column located on the right side of FIG. 15, so that the customer may access and the financial data downloaded from the financial institutions linked to the server 18 according to the assigned FR-PIN.

FIG. 14 is a screen view of a customer's data web page 372. Displayed on the web page 372 are a grouping of four photos 374, each having a title block 376 for displaying a title defined by the customer. The window 378 lists a category tree for selecting between various photos for display, according to the listed categories. The frame 380 is provided to list a customer selected title, such as the customer's personal name, family name, or any other such title assigned by the customer. The buttons 388 provide links for displaying various groupings of the personal records of the customer, defined by the display codes.

FIG. 15 is a screen view of a customer's personal web page 392. The personal web page 392 may provide a family portrait 394, with a family name title displayed thereabove. Additionally, a customer may select various other categories for display. The personal web page 392 lists links to the family web page, lists links to sites which are personal to adults of the family, and lists links to sites which are personal to the two children in the particular family. Various other informational and entertainment options may be listed by the customer on the family web page 392 for access by the customer or a visitor. Links to personal financial records for the customer are shown on the column located on the right side of the web page 392.

FIGS. 16 through 18 set forth in tabular form the digits for various portions of index codes assigned to the personal records according to one embodiment of the present invention. FIG. 16 is a tabular listing of the first 6 digits which are assigned to the index codes for the personal records. The first digit indicates a type of the personal record, which identifies broad general categories of the personal records, such as broad categories for business records, household records, and the like. The second, third and fourth digits indicate an update number. The fifth and sixth digits of an index code indicate the type of data record, such as whether it is a JPEG file of a photographic image, a video file, or an audio file.

FIGS. 17A and 17B together provide a tabular listing of digits corresponding to various categories which are used for the index codes which correspond to various categories for the personal records. The seventh and eight digits relate to the top level of a category for classifying the records of a particular customer. The ninth and tenth digits of the index codes relate to a subcategory of the top level category, and the eleventh and twelfth digits relate to a sub category of the sub-category indicated by the ninth and tenth digits of the index codes.

FIG. 18 is a table which shows that the thirteenth through the sixteenth digits of the index codes define a chronological sequence code (“CSC”) which identifies the chronological order for the various personal records. Preferably, the CSC corresponds to event dates for the records, which is coded to identify a chronological sequence in which the various personal records occurred. However, the order of the preferred chronological sequence listing may be modified by the customer in a manual sort, such that the thirteenth through the sixteenth digits correspond to a selected sort order of the customer.

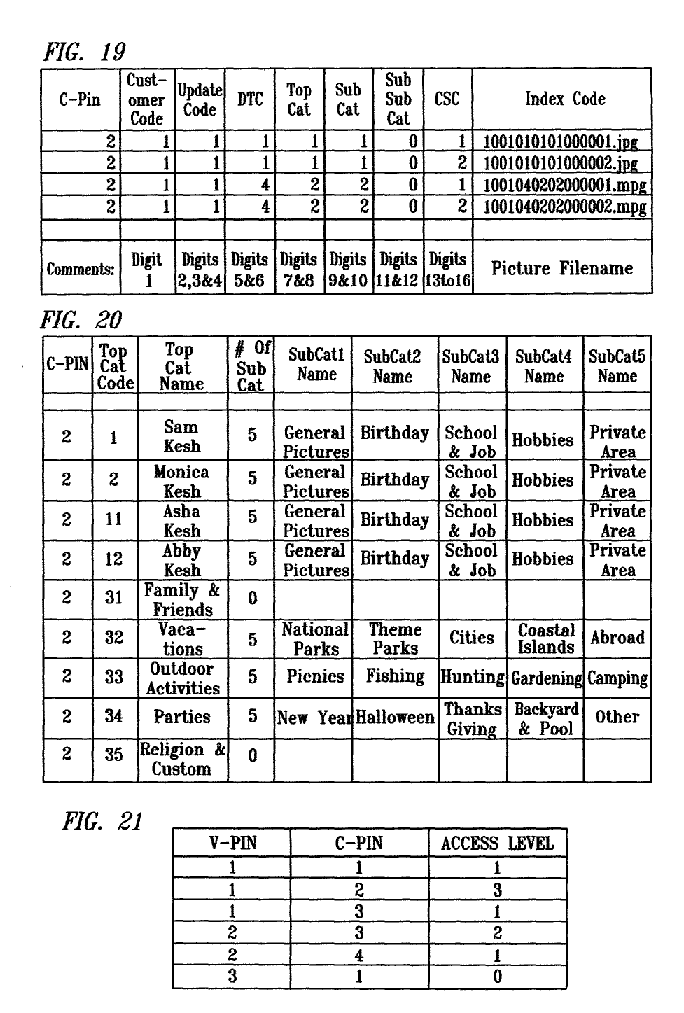

FIG. 19 is a table depicting several index codes, and the various code category information which comprise the index code. As shown, preferably a file name is assigned to each of the personal records which corresponds to the various digits of the index code, providing for ease of sorting and locating of the various personal record files. The various digits of the index codes to which the categories and subcategories correspond are shown linked to the file name for the personal records.

FIG. 20 is a table showing an example of various category listings assigned by a particular customer to the index code categories, and index code subcategories. Various family names, family events, and activities of the family members have been assigned to categories and subcategories corresponding to the index codes.

FIG. 21 is a table which lists various V-PIN codes corresponding to various C-PIN codes. It should be noted that a particular C-PIN may correspond to a number of V-PINs, for viewing the various records of others. As discussed above, a V-PIN is used to visit the various records of others formatted web pages, viewable with a web browser over a global computer network.

The present invention provides various advantages over the prior art for providing a method and system for categorizing personal records, and storing such personal records on the server. The present invention provides automatic categorization and later customer sorting of the categories, and then sorting of the various personal records into the various categories and index coding of the personal records such that a simple category tree may be followed to retrieve the records by either a customer or visitor. The customer may grant visitor's rights for viewing the records remotely. Additionally, remote storage is provided such that such personal records may not be destroyed, but my be retained in perpetuity without risk of damage from catastrophe to the customer's home or site.

Although the preferred embodiment has been described in detail, it should be understood that various changes, substitutions and alterations can be made therein without departing from the spirit and scope of the invention as defined by the appended claims.

What is claimed is:

1. A method for storing personal records in a data processing system, the method comprising the steps of:
sorting the personal records into a preselected order defined according to a selected input scheme;
inputting the personal records into a data processing system for storage in a machine readable storage media;
assigning index codes to the personal records, wherein the index codes correspond to a sequence in which the personal records are input into the data processing system;
formatting the personal records for remote display;
automatically performing a machine sort of the personal records according to the index codes;
grouping the personal records into display sets according to the assigned index codes, for simultaneous display;
assigning display codes to the personal records according to the groupings of the display sets; and
displaying a display set of the personal records in response to a remote display request.

2. The method according to claim 1, wherein the display codes are incorporated into the index codes.

3. The method according to claim 1, wherein the step of sorting comprises separating each of the personal records into separate categories which correspond to particular persons and events in the particular persons' lives.

4. The method according to claim 3, wherein the step of sorting further comprises sorting the personal records within categories into a chronological order of events.

5. The method according to claim 4, further comprising the step of assigning a V-PIN to grant remote viewing access of the personal records to a visitor.

6. The method according to claim 1, further comprising the step of selecting a category structure for assigning the records into the selected category structure from a standardized category structure, and then editing the selected category structure for sorting the personal records into a customer selected display scheme.

7. The method according to claim 1, further comprising the steps of:
inputting personal data of a particular customer into the data processing system;
identifying key calendar data corresponding to the particular customer;
assigning event dates to the key calendar data identified for the customer;
assigning trigger dates to identified event dates of the key calendar data, and storing the trigger dates in the data processing system;
monitoring the trigger dates; and
forwarding an alert to the particular customer in response to detecting a trigger date which corresponds to the identified event date of the key calendar data, the alert prompting the customer to forward additional personal records corresponding to the identified event date of the key calendar data.

8. The method according to claim 7, wherein the personal records of the customer include photographic images, video recordings, audio recordings and documents.

9. The method according to claim 1, further comprising the steps of:
assigning a financial records personal identification number (“FR-PIN”) to a customer which correlates to identity codes of financial institutions and financial accounts of the customer in the financial institutions;
linking through a global computer network to the financial institutions for receipt of financial records of the customer;
receiving and storing the financial records of the customer; and
displaying the financial records in response to a query of the customer.

10. A method for storing personal records in a data processing system, the method comprising the steps of:
sorting the personal records into a preselected order defined according to a selected input scheme, which includes separating each of the personal records into separate categories which correspond to particular persons and events in the persons' lives and arranging the personal records within categories into a chronological order of the events;
inputting the personal records into a data processing system for storage in a machine readable storage media;
during the step of inputting, automatically assigning index codes to the personal records, wherein the index codes correspond to a sequence in which the personal records are input into the data processing system;
formatting the personal records for remote display;
automatically performing a machine sort of the personal records according to the index codes;
grouping the personal records into display sets according to the assigned index codes, for simultaneous display;
assigning display codes to the personal records according to the groupings of the display sets, wherein the display codes are incorporated into the index codes corresponding to the personal records;
assigning a V-PIN to grant remote viewing access of the personal records to a visitor; and
displaying the a display set of the personal records in response to a remote display request.

11. The method according to claim 10, further comprising the steps of selecting a category structure for assigning the records into the selected category structure from a standardized category structure, and then editing the selected category structure for sorting the personal records into a customer selected display scheme.

12. The method according to claim 10, further comprising the steps of:
inputting personal data of a particular customer into the data processing system;
identifying key calendar data corresponding to the particular customer,
assigning event dates to the key calendar data identified for the customer;
assigning trigger dates to identified event dates of the key calendar data, and storing the trigger dates in the data processing system;
monitoring the trigger dates; and
forwarding an alert to the particular customer in response to detecting a trigger date which corresponds to the identified event date of the key calendar data, the alert prompting the customer to forward additional personal records corresponding to the identified event date of the key calendar data.

13. The method according to claim 10, further comprising the steps of:
assigning a financial records personal identification number (“FR-PIN”) to a customer which correlates to identity codes of financial institutions and financial accounts of the customer in the financial institutions;
linking through a global computer network to the financial institutions for receipt of financial records of the customer;
receiving and storing the financial records of the customer; and
displaying the financial records in response to a query of the customer.

14. A method for inputting personal records of a customer in a data processing system, comprising the steps of:
selecting loose photographs and photographic albums from personal records of a customer;
digitizing the personal records which are selected using high speed, automatic feeding, digitization equipment;
performing the step of digitizing in a mobile data center near a customer site;
assigning index codes corresponding to each of the digitized personal records; and
storing such digitized records in a client computer for input into the data processing system.

15. A method for storing personal records in a data processing system, the method comprising the steps of:
sorting the personal records into a preselected order defined according to a selected input scheme, which includes separating each of the personal records into separate categories which correspond to particular persons and events in the particular persons' lives and arranging the personal records within categories into a chronological order of the events;
inputting the personal records into a data processing system for storage in a machine readable storage media;
during the step of inputting, automatically assigning index codes to the personal records, wherein the index codes correspond to a sequence in which the personal records are input into the data processing system;
formatting the personal records for remote display;
automatically performing a machine sort of the personal records according to the index codes;
grouping the personal records into display sets according to the assigned index codes, for simultaneous display of records in particular display sets as web pages;
assigning display codes to the personal records according to the groupings of the display sets, wherein the display codes are incorporated into the index codes corresponding to the personal records;
assigning a V-PIN to grant remote viewing access of the personal records to a visitor; and
displaying the display set of the personal records in response to a remote display request.

16. The method according to claim 15, further comprising the steps of selecting a category structure for assigning the records into the selected category structure from a standardized category structure, and then editing the selected category structure for sorting the personal records into a customer selected display scheme.

17. The method according to claim 16, further comprising the steps of:
inputting personal data of a particular customer into the data processing system;
identifying key calendar data corresponding to the particular customer;
assigning event dates to the key calendar data identified for the customer;
assigning trigger dates to identified event dates of the key calendar data, and storing the trigger dates in the data processing system;
monitoring the trigger dates; and
forwarding an alert to the particular customer in response to detecting a trigger date which corresponds to the identified event date of the key calendar data, the alert prompting the customer to forward additional personal records corresponding to the identified event date of the key calendar data.

18. The method according to claim 17, further comprising the steps of:
assigning a financial records personal identification number (“FR-PIN”) to a customer which correlates to identity codes of financial institutions and financial accounts of the customer in the financial institutions;
linking through a global computer network to the financial institutions for receipt of financial records of the customer,
receiving and storing the financial records of the customer; and
displaying the financial records in response to a query of the customer.

19. The method according to claim 15, further comprising the steps:
of selecting a category structure for assigning the records into the category structure from a standardized category structure;,
inputting personal data of a particular customer into the data processing system;
identifying key calendar data corresponding to the particular customer,
assigning event dates to the key calendar data identified for the customer;
assigning trigger dates to identified event dates of the key calendar data, and storing the trigger dates in the data processing system;
monitoring the trigger dates; and
forwarding an alert to the particular customer in response to detecting a trigger date which corresponds to the identified event date of the key calendar data, the alert prompting the customer to forward additional personal records corresponding to the identified event date of the key calendar data.

20. The method according to claim 15, further comprising the steps of:
inputting personal data of a particular customer into the data processing system;
identifying key calendar data corresponding to the particular customer;
assigning event dates to the key calendar data identified for the customer;
assigning trigger dates to identified event dates of the key calendar data, and storing the trigger dates in the data processing system;
monitoring the trigger dates;
forwarding an alert to the particular customer in response to detecting a trigger date which corresponds to the identified event date of the key calendar data, the alert prompting the customer to forward additional personal records corresponding to the identified event date of the key calendar data;
assigning a financial records personal identification number (“FR-PIN”) to a customer which correlates to identity codes of financial institutions and financial accounts of the customer in the financial institutions;
linking through a global computer network to the financial institutions for receipt of financial records of the customer;
receiving and storing the financial records of the customer; and
displaying the financial records in response to a query of the customer.

21. The method according to claim 20, further comprising the steps of selecting a category structure for assigning the records into the selected category structure from a standardized category structure, and then editing the selected category structure for sorting the personal records into a customer selected display scheme.
